(19) United States
(12) Patent Application Publication
(10) Pub. No.: US 2014/0368443 A1
(43) Pub. Date: Dec. 18, 2014

(54) System for Automating Laboratory Experiments

(71) Applicant: Agilent Technologies, Inc., Loveland, CO (US)

(72) Inventors: Robert Kincaid, Half Moon Bay, CA (US); Melanie Tory, Sunnyvale, CA (US)

(21) Appl. No.: 13/918,572

(22) Filed: Jun. 14, 2013

(51) Int. Cl. B01L 9/00; G06F 3/041

(52) U.S. Cl. CPC B01L 9/523; G06F 3/041
USPC 345/173

(57) ABSTRACT

An adapter and systems using multiple such adapters are disclosed. The adapter includes a controller and a top surface having a display area and a component area adapted to receive a component. The display area displays an image determined by the controller, the image providing information about the component. In one aspect of the invention, the top surface includes a computer display screen that can also be a touch enabled screen. The adapters can be used with a plurality of different components and are reusable. The computer display screen can include a detent mechanism for positioning the component. The controller can determine an identity, a location, an orientation for the component based on a touch pattern on the touch enabled computer screen. The adapter can also include a sensor measuring a property of the component such as the temperature or weight of the component.

### BACKGROUND

Many laboratory experiments involve manipulations of objects on a work surface in which the objects are in more or less arbitrary positions and orientations. In addition, the objects can have components that are actually the target of the manipulations. For example, biological experiments often involve moving liquid from one well of a microtiter plate to a corresponding well in another microtiter plate. The procedure is repeated numerous times with different wells. The size of the wells is small and the number of wells are in the hundreds. Hence, the possibility of errors in either the well of origin or the destination well can be significant.

In addition, the experimenter often needs to keep a log of the manipulations. In some cases, the time at which the transfer takes place must also be recorded. In addition, the state of the reagents may need to be monitored to ensure that the temperature of the reagents is maintained within predetermined limits.

Systems based on cameras that record the operations on a work surface and projectors that illuminate areas of interest have been suggested. However, such systems have limited optical resolution, and hence, identifying a small well on a surface that may be 3′×6′ presents challenges when the well of origin and the destination wells are only one-quarter of an inch in diameter. In addition, monitoring reagent states and other experimental variables that are not easily monitored through a camera present significant challenges. Finally, the user can block the projection path.

In addition, camera based systems require a fixed installation. Often a combination of a camera and a projector are used to implement a large display. Moving such a system requires that the mounting system be moved and that the calibration of the camera and projector be repeated at each new location. The calibration of the system presents challenges in systems requiring high resolution for the coordination of the camera image and projector output.

### SUMMARY OF THE INVENTION

The present invention includes an adapter and systems using multiple such adapters. The adapter includes a controller and a top surface having a display area and a first component area adapted to receive a first component. The display area displays an image determined by the controller, the image providing information about the first component. In one aspect of the invention, the top surface includes a computer display screen that can also be a touch enabled computer display screen.

In another aspect of the invention, the first component area includes an area on the computer display screen which includes a detent mechanism for positioning the first component. The display area can be a portion of the computer display screen. The controller can determine an identity for the first component based on a touch pattern on the touch enabled computer screen.

In a further aspect of the invention, the adapter includes a wireless communication link for communicating information about the first component. In a still further aspect of the invention, the controller selectively illuminates part of the first component in response to a command received on the wireless communication link.

In yet another aspect of the invention, the adapter includes a sensor that measures a property of the first component. For example, the sensor measures the temperature or weight of the first component.

In a still further aspect of the invention, the adapter includes the controller which determines a location and orientation of the first component in the first component area.

In another aspect of the invention, the adapter includes a second component area adapted to receive a second component, the image providing information about the second component. The controller selectively illuminates a portion of the second component and displays information about an operation to be performed between an illuminated portion of the first component and the illuminated portion of the second component.

In another aspect of the invention, the first component is reversibly attached to the first adapter. The first component area is adapted for receiving multiple, different first components.

A system according to the present invention includes first and second adapters and a controller. The first adapter has a top surface that includes a first display area and a first component area adapted to receive a first component, the first display area displaying an image providing information about the first component The second adapter has a top surface that includes a second display area and a second component area adapted to receive a second component, the second display area displaying an image providing information about the second component. The controller determines the images displayed in the first and second display areas.

In one aspect of the invention, the system includes a work surface in contact with the first and second display adapters and a projector for displaying a third image on the work surface. The third image includes information about an operation to be performed involving the first and second components. The system can also include a camera that provides an image of the work surface and the first and second adapters to the controller. The first and second adapters include wireless communication links that link the adapters to the controller.

### BRIEF DESCRIPTION OF THE DRAWINGS

FIG. 1 illustrates an adapter according to one embodiment of the present invention.

FIG. 2 illustrates an adapter according to another embodiment of the present invention.

FIG. 3 illustrates the setup of the experiment shown in FIG. 2 as it would appear if the special adapter that holds two microtiter well plates were replaced by two individual microtiter well plate adapters.

FIG. 4 illustrates an adapter according to one embodiment of the present invention in which the area that receives the object includes two types of sensors.

FIG. 5 is a cross-sectional view of an experimental setup that utilizes a number of adapters according to the present invention in conjunction with a camera and projector.

### DETAILED DESCRIPTION

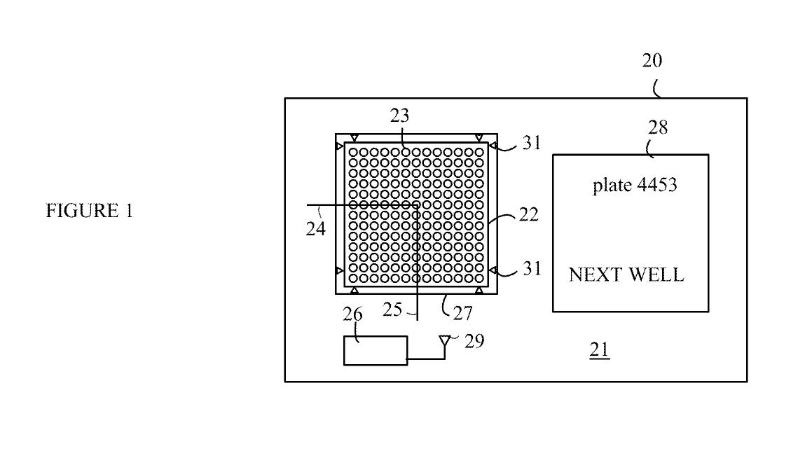

The manner in which the present invention provides its advantages can be more easily understood with reference to an embodiment of the present invention that utilizes an adapter on which experimental components are placed. Refer now to FIG. 1, which illustrates an adapter according to one embodiment of the present invention. Adapter 20 includes a display surface 21 on which an experimental component 22 is placed. In the present example, the experimental component is a microtiter well plate having a rectangular array of wells 23. In this exemplary embodiment, the position and orientation of microtiter well plate 22 is fixed by a cut-out 27 on the surface of display surface 21; however, as will be explained in more detail below, embodiments in which the position and orientation of the experimental component is automatically determined can also be constructed.

Display surface 21 is analogous to a tablet computer in that an image can be displayed on display surface 21 under microtiter well plate 22 and in region 28. A particular well within microtiter well plate 22 can be indicated by displaying two lines that intersect at the well in question as shown by lines 24 and 25. The display pattern is determined by a processor 26 within adapter 20 which communicates with a controller that coordinates the displays on various adapters on the work surface. The material displayed on display surface 21 can include information about the object in adapter 20 or instructions to the technician. An experimental setup based on the adapters of the present invention can involve multiple adapters or a single adapter. In setups that involve multiple adapters or a separate controller that operates in conjunction with adapter 20, the various adapters in an experimental setup communicate with the controller via a radio link indicated by antenna 29. It should be noted that resolution of the display within the adapter is very high, typically more than 100 lines per inch. Hence, a well or other feature can be illuminated with high accuracy on display surface 21.

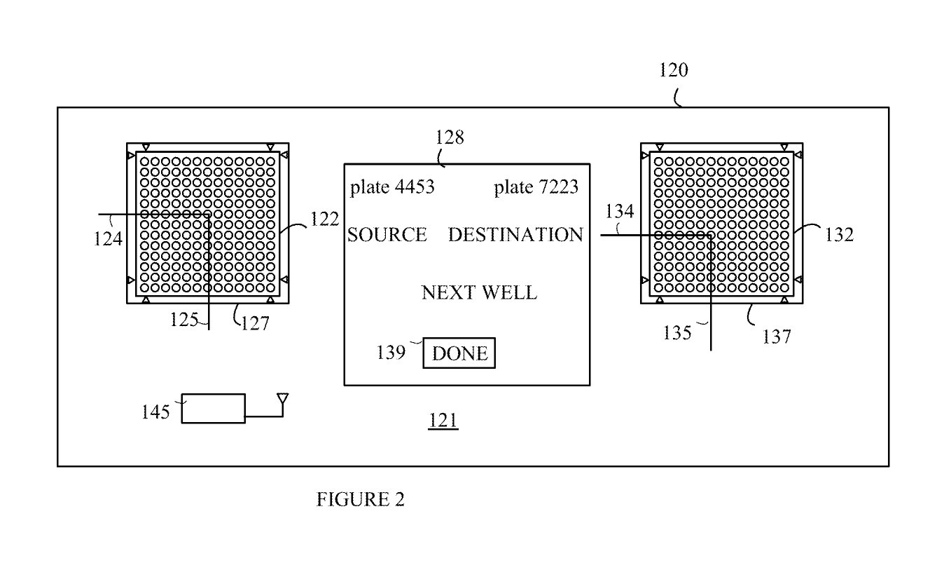

In some cases, a single adapter has sufficient resources to interface with all of the necessary components in an experimental setup. Refer now to FIG. 2, which illustrates an adapter according to another embodiment of the present invention. Adapter 120 includes recessed areas 127 and 137 that each hold a different microtiter well plate, which are shown at 122 and 132, respectively. The display area at 128 in display surface 121 provides information about the plates and instructions to the user. A source well is indicated by lines 124 and 125 and the destination well is shown by lines 134 and 135.

Consider a case in which the experimental protocol being run through controller 145 involves a series of liquid transfers in which a sample is moved from a well on microtiter well plate 122 to a corresponding well on microtiter well plate 132. Controller 145 illuminates the origin well in microtiter well plate 122 and the destination well in microtiter well plate 132. After the technician makes the indicated transfer, the technician signals controller 145 by touching a virtual button 139 in display area 128, and controller 145 illuminates the next origin and destination wells. Controller 145 also makes corresponding entries in the log for the experiment indicating the time of the transfer and any additional information required by the protocol, such as temperature of the trays.

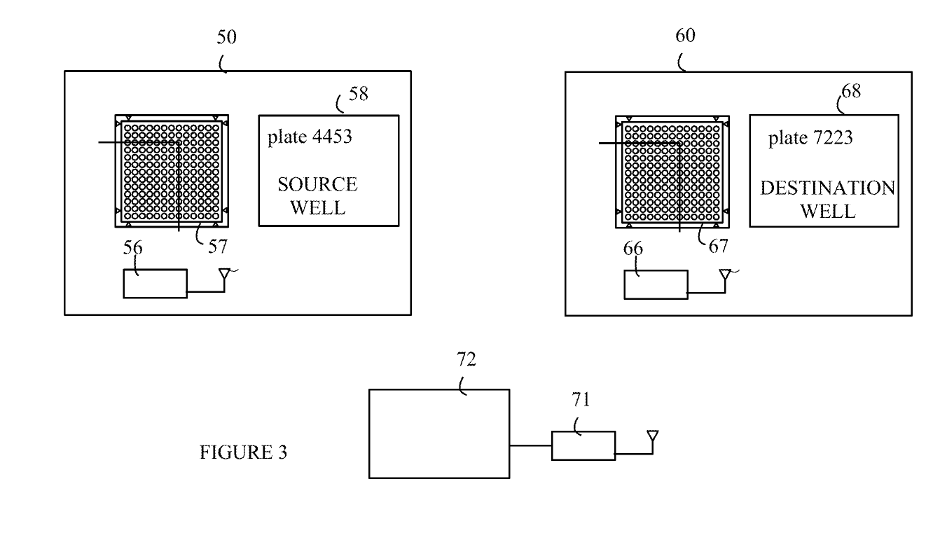

The same experimental setup shown in FIG. 2 could be carried out using multiple adapters of the type shown in FIG. 1. Refer now to FIG. 3, which illustrates the setup of the experiment shown in FIG. 2 as it would appear if the special adapter that holds two microtiter well plates were replaced by two individual microtiter well plate adapters. In this case, the source microtiter well plate 57 is placed in adapter 50 and the destination microtiter well plate 67 is placed in adapter 60. Display 58 in adapter 50 is under the control of controller 56, and display 68 in adapter 60 is under the control of controller 66. In this example, the two controllers communicate with a central computer 71 that includes a separate graphical user interface 72, which may include a touch screen or other input device such as a keyboard/mouse. It should be noted; however, that the controller in one of the adapters could also provide the central control for the experiment.

Using separate adapters has a number of advantages. First, the laboratory does not have to stock as many different adapters. The individual adapters shown in FIG. 3 could be utilized in a different experiment requiring a different number of adapters of this type. Whereas the adapter for two microtiter well plates is not as convenient for an experimental setup requiring an odd number of microtiter well plates.

Second, adapters can be constructed from the same hardware as an inexpensive small tablet computer. In this case, the entire surface of the adapter is a single touch screen surface. The cost of such displays increases rapidly with the size of the touch screen. Hence, a number of small touch screens are significantly less costly than one large touch screen with the same area. Furthermore, many experimental setups will include areas in which a display surface is not needed. For example, the area between adapters 50 and 60 does not require touch screen capability.

Third, the required definition of the display surface is substantially less with multiple screens. For example, to provide illumination of a particular well, the display surface must be able to generate a line with an accuracy that is small compared to the distance between the wells. A touch screen that provides this resolution over the area of a work bench in a laboratory would be prohibitively expensive for many applications. In contrast, each smaller display surface needs only to provide this resolution over the area of the device that it includes and any communication area.

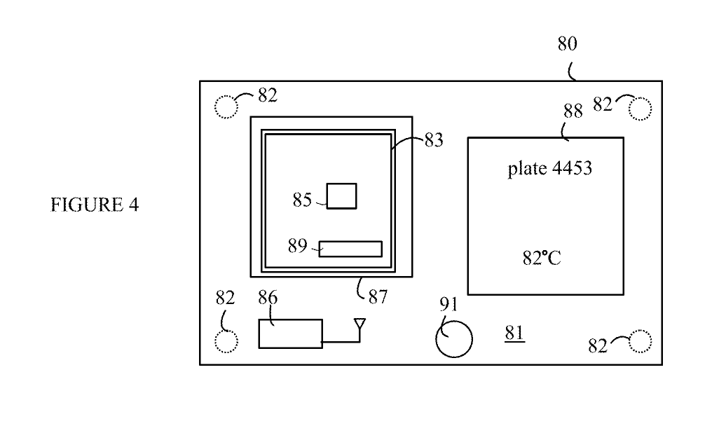

In one aspect of the invention, an adapter according to the present invention also includes one or more sensors that measure properties of the object that is placed in the adapter. Refer now to FIG. 4, which illustrates an adapter 80 according to one embodiment of the present invention in which the area 87 that receives the object includes two types of sensors. The first type of sensor is a temperature sensor 85. Temperature sensor 85 measures the temperature of the object placed thereon. The measured temperature is communicated to controller 86 which displays the temperature in communication area 88 that is provided on surface 81. The temperature can be recorded in the log of the experiment being conducted. In addition, controller 86 can display an alarm if the temperature exceeds some predetermined limit that is specified in the experimental protocol.

The second class of sensors are pressure sensors 82 that measure the weight of the adapter together with any object placed thereon. For example, if the adapter is being used to monitor a reagent reservoir that contains a reagent that is used in an experiment, controller 86 can determine the amount of reagent in the reservoir from the known weight of the adapter and container containing the reagent. Controller 86 can then alert the experimenter if there is insufficient reagent to complete the experiment.

Adapter 80 can also include an antenna 83 for exciting an RFID tag that is attached to the object placed in adapter 80. The RFID tag is then read by controller 86 and used to identify the object placed on adapter 80. The information encoded in the RFID tag can be compared with a listing stored in controller 86 that identifies the expected object for the experiment in question. In another aspect of the invention, adapter 80 includes an optical bar code reader 89 that provides an analogous function to the RHD tag reader. If controller 86 detects that the wrong object is placed in adapter 90, controller 86 can generate an alarm message in communication area 88 or cause an audible alarm to be sounded using a speaker 91 that is part of adapter 80 or part of a system controller such as graphical user interface 72 shown in FIG. 3.

Area 87 in which objects that are to be used with the adapter are placed can also be a touch enabled display surface. In such embodiments, the object being placed in area 87 can include protrusions on the bottom surface thereof that can be sensed by the touch enabled surface. If the surface is a multi-touch surface, the pattern and location of the protrusion can be used to provide information about the object and its orientation and location on the adapter. Hence, the same adapter can be used for a variety of objects of different shapes and sizes.

In another aspect of the invention, the surface of area 87 can sense the objects placed on the surface optically without the use of a camera using a technology such as the Microsoft Pixel Sense technology. In this case, the surface of area 87 can read an optical tag that includes a bar code or similar pattern to determine the object and orientation that is placed in area 87.

In a still further aspect of the invention, area 87 can be configured to accept a number of inserts that customize the space in area 87 such that the space provides an area that accepts an object of a predetermined size and orientation. For example, the spacers shown at 31 in FIG. 1 provide such a function.

While the above-described embodiments of the present invention utilize one or more adapters according to the present invention to provide the experimental setup, the adapters of the present invention can also be advantageously used in conjunction with other types of automation. Since the high definition illumination of wells and other small parts of an object on an adapter according to the present invention can be provided by the display surface on the adapter, an experimental setup can use a second lower resolution camera to monitor other portions of the experimental setup without the calibration and resolution limitations of conventional camera and projector systems. Similarly, a low resolution projector can be used to project an image onto a surface between the adapters to provide other information to the user.

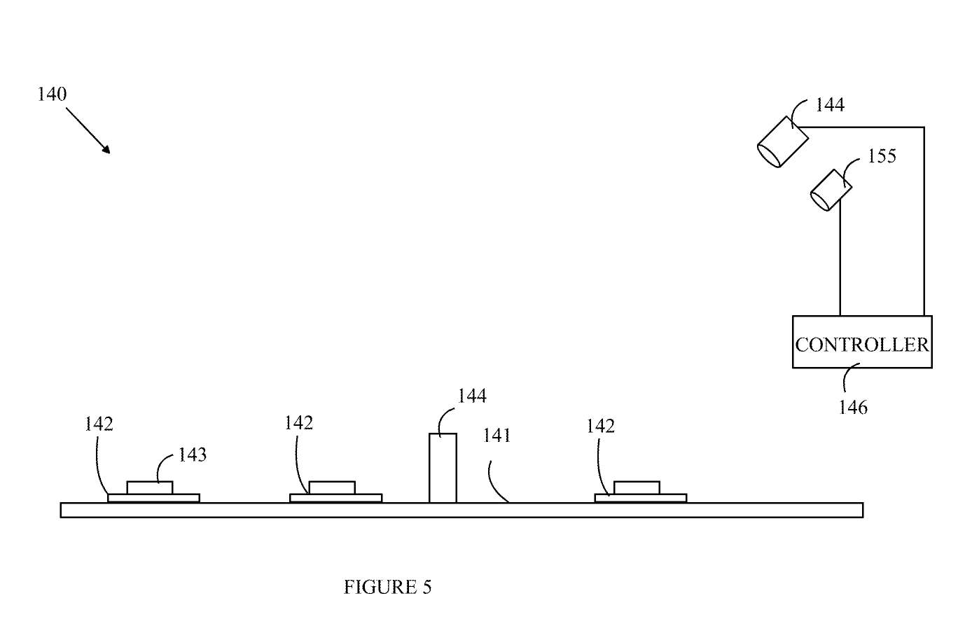

Refer now to FIG. 5, which is a cross-sectional view of an experimental setup that utilizes a number of adapters according to the present invention in conjunction with a camera and projector. Experimental setup 140 includes a work surface 141 on which a plurality of adapters 142 according to the present invention are placed. Each adapter has a component 143 that is managed by that adapter. In addition, components such as camera 144 that are not connected to an adapter may be present on work surface 141. The positions of the various adapters and components are monitored by a camera 144 that is under the control of controller 146. Controller 146 also controls a projector 155 that can be used to display images on work surface 141. In one aspect of the invention, controller 146 emulates a keyboard and display screen on a portion of work surface 141 that is not covered by adapters or other components. Controller 146 can also direct the user's attention to a specific component by utilizing projector 155 to illuminate the component in question.

Controller 146 also communicates with the various adapters of the present invention. In one aspect of the invention, controller 146 identifies a specific adapter by sending a command to the adapter in question that causes the adapter to respond in a manner that can be viewed by camera 144. For example, controller 146 can send a command to an adapter having a specified IP address to cause the adapter to respond in a manner that allows the controller to identify the adapter location on the work surface. For example, the adapter could display a pattern on the display surface associated with that adapter in response to a command from controller 146. Controller 146 could then identify the adapter by the illumination pattern on the display surface of that adapter. In this manner, controller 146 can determine the location and orientation of each adapter on work surface 141. This aspect of the present invention allows the controller to discover the true experimental setup from a listing of the components in that experimental setup and the addresses of the adapters on which those components reside.

In the above-described embodiment, the camera and projector are over the work surface; however, embodiments in which a camera and/or projector are below a transparent work surface can also be constructed. In addition, the surface on which the adapters are placed could be a surface that optically senses the adapters without the use of a camera such as the Pixel Sense surface discussed above. Further, the work surface could be an optical display surface such as an LCD screen.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. An apparatus comprising:
a controller and
a top surface comprising a display area and a first component area adapted to receive a first component, said display area displaying an image determined by said controller, said image providing information about said first component.

2. The apparatus of claim 1 wherein said top surface comprises a computer display screen.

3. The apparatus of claim 2 wherein said first component area comprises an area on said computer display screen comprising a detent mechanism for positioning said first component.

4. The apparatus of claim 2 wherein said display area is a portion of said computer display screen.

5. The apparatus of claim 2 wherein said computer display screen is a touch enabled computer display screen.

6. The apparatus of claim 2 wherein said controller determines an identity for said first component based on a touch pattern on said touch enabled computer display screen.

7. The apparatus of claim 1 further comprising a wireless communication link for communicating information about said first component.

8. The apparatus of claim 2 wherein said controller selectively illuminates part of said first component in response to a command received on said wireless communication link.

9. The apparatus of claim 1 further comprising a sensor that measures a property of said first component.

10. The apparatus of claim 9 wherein said sensor measures a temperature of said first component.

11. The apparatus of claim 9 wherein said sensor measures a weight associated with said first component.

12. The apparatus of claim 1 wherein said controller determines a location and orientation of said first component in said first component area.

13. The apparatus of claim 1 further comprising a second component area adapted to receive a second component, said image providing information about said second component.

14. The apparatus of claim 1 wherein said controller selectively illuminates a portion of said second component and displays information about an operation to be performed between an illuminated portion of said first component and said illuminated portion of said second component.

15. The apparatus of claim 1 wherein said first component is reversibly attached to said first component area.

16. The apparatus of claim 1 wherein said first component area is adapted for receiving multiple, different first components.

17. A system comprising:
a first adapter having a top surface comprising a first display area and a first component area adapted to receive a first component, said first display area displaying an image providing information about said first component;
a second adapter having a top surface comprising a second display area and a second component area adapted to receive a second component, said second display area displaying an image providing information about said second component; and
a controller that determines said images displayed in said first and second display areas.

18. The system of claim 17 further comprising a work surface in contact with said first and second adapters and a projector for displaying a third image on said work surface, said third image comprising information about an operation to be performed involving said first and second components.

19. The system of claim 17 comprising a camera that provides an image of said work surface and said first adapter and said second adapter to said controller.

20. The system of claim 17 wherein said first adapter and said second adapter comprise wireless communication links that link said adapters to said controller.
